(19) United States
(12) Patent Application Publication
(10) Pub. No.: US 2014/0049162 A1
(43) Pub. Date: Feb. 20, 2014

(54) DEFECT REDUCTION IN PLASMA PROCESSING

(71) Applicants: George Thomas, Fremont, CA (US); Bart van Schravendijk, Sunnyvale, CA (US); Harald Te Nijenhuis, San Jose, CA (US); Shawn Hamilton, Boulder Creek, CA (US)

(72) Inventors: George Thomas, Fremont, CA (US); Bart van Schravendijk, Sunnyvale, CA (US); Harald Te Nijenhuis, San Jose, CA (US); Shawn Hamilton, Boulder Creek, CA (US); Konstantin Makhratchev, Fremont, CA (US)

(21) Appl. No.: 13/586,790

(22) Filed: Aug. 15, 2012

(51) Int. Cl. H05H 1/24

(52) U.S. Cl. CPC H05H 1/24
USPC 315/111.21

(57) ABSTRACT

Methods and apparatus to reduce particle-induced defects on a substrate are provided. In certain embodiments, the methods involve decreasing plasma spread prior to extinguishing the plasma. The plasma is maintained at the decreased plasma spread while particles are evacuated from the processing chamber. In certain embodiments, the methods involve decreasing plasma power prior to extinguishing the plasma. The low-power plasma is maintained while particles are evacuated from the processing chamber.

### BACKGROUND

Plasma processing may be used for a variety of applications. For example, plasma-enhanced chemical vapor deposition (PECVD) processes utilize plasma energy to deposit thin films of material on a substrate. Plasma is any gas in which a significant percentage of the atoms or molecules are ionized. The plasma may be generated by different methods, for example, with a direct-current discharge, a capacitive discharge, or an inductive discharge. A capacitive discharge can be created by RF frequency between two parallel electrodes as well with a single electrode. The RF may be generated at very high, high, medium or low high frequency. For example, it can be generated at a standard 13.56 MHz (high frequency), and optionally at lower and higher frequencies. Reactive gases, also known as precursors, are fed into the plasma. The plasma energy causes the reactive gases to decompose and deposit on or remove material from the wafer surface. In addition to PECVD and other plasma-based deposition processes, plasma processing may also be used to remove material, provide surface conditioning or functionalization, and otherwise treat substrates. During plasma processing, particles may be generated and accumulate in the plasma.

### SUMMARY OF THE INVENTION

The present invention provides methods and apparatus to reduce particle-induced defects on a substrate during deposition, removal, and/or treatment operations in process. In certain embodiments, the methods involve decreasing plasma spread prior to extinguishing the plasma and maintaining the decreased plasma spread while particles are evacuated from the processing chamber. In certain embodiments, the methods involve decreasing plasma power prior to extinguishing the plasma. The low-power plasma is maintained while particles are evacuated from the processing chamber.

One aspect of the invention relates to a method involving exposing a substrate in a process chamber to a plasma at a first plasma power; and performing a plasma extinguishing process in which the first plasma power is reduced to a second plasma power, second plasma power is maintained for a first duration, and after the first duration, extinguishing the plasma.

The plasma can be any type of plasma including an DC, RF or microwave plasma. According to various embodiments, the plasma power can be ramped down or stepped down through one or more intermediate power levels. The second plasma power can be low enough that metal particle generation from the plasma eroding is substantially reduced. The first duration can be long enough to substantially remove metal particles suspended in the plasma.

In some embodiments, the methods involve stepping down through two, three, or more intermediate power levels prior to reaching the second plasma power. In some embodiments, the second power level is a power at or close to the minimum power level at which a plasma can be maintained. In some embodiments, the second power level is at or close to the level at which the plasma spread is at minimum.

Another aspect of the invention relates to a method including generating a plasma in a processing chamber; exposing a substrate in the processing chamber to the plasma; reducing the plasma spread; and flushing particles from the chamber while the plasma is at the reduced spread.

Yet another aspect of the invention relates to an apparatus including a substrate support; a first electrode electrically connected to a first plasma generator; a second electrode; a pumping port; and a controller, said controller comprising instructions for applying a first power to the first electrode, reducing the first power to a second power, maintaining the second power for a first duration, and turning off power to the first electrode.

These and other features and advantages of the present invention will be described in more detail below with reference to the associated drawings.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIGS. 1A and 1B are a graphical depiction of a plasma processing chamber.

FIGS. 2 and 3 are process flow diagrams of example methods suitable for implementing the present invention.

FIGS. 4A-4C are cross sectional schematics depicting various stages of a method in accordance with an embodiment of the present invention.

FIGS. 5A and 5B are diagrams depicting plasma power vs. time according to certain embodiments.

FIG. 6 shows bias match data in a RF system for RF power turned off with 250 W, 180 W, 110 W and 30 W steps.

FIG. 7 shows bias match data in a RF system for RF power turned off with 250 W, 180 W, 110 W and 30 W steps.

FIG. 8 provides a simple block diagram depicting various components arranged for implementing the methods described herein.

### DETAILED DESCRIPTION

### Introduction

Embodiments of the present invention are described herein in the context of a plasma processing of semiconductor devices. Those skilled in the art will realize that the following detailed description of the present invention is illustrative only and is not intended to be in any way limiting. Other embodiments of the present invention will readily suggest themselves to such skilled persons having the benefit of this disclosure. For example, the methods and apparatus described herein may be used to reduce particle contamination on displays and any other device that undergoes plasma processing. Reference will now be made in detail to implementations of the present invention as illustrated in the accompanying drawings. The same reference indicators will be used throughout the drawings and the following detailed description to refer to the same or like parts.

The term “semiconductor device” as used herein refers to any device formed on a semiconductor substrate or any device possessing a semiconductor material. In many cases, a semiconductor device participates in electronic logic or memory, or in energy conversion. The term “semiconductor device” subsumes partially fabricated devices (such as partially fabricated integrated circuits) as well as completed devices available for sale or installed in particular apparatus. In short, a semiconductor device may exist at any state of manufacture that employs a method of this invention or possesses a structure of this invention. The terms “wafer” and “substrate” refers to the work pieces on which processing may be performed and may be used interchangeably in this disclosure. As noted above, the methods and apparatus described herein may be used in connection with plasma processing of any type of substrate including semiconductor device, display device and other substrates.

As noted above, the present invention provides a method of reducing plasma-induced contamination on substrates during plasma processing. Plasmas used in plasma processing can generate particles. Plasma energy can be used, for example, to decompose chemical precursors and deposit on, remove material from, or treat substrate surfaces.

Plasma can be generated by a number of different types of plasma generators including DC, RF and microwave plasma sources. Power can be applied one or more electrodes to deliver energy to a process area between the electrodes. For example, RF energy at a high frequency can be applied to a showerhead in a chamber through which a plasma process gas flows, with the showerhead acting as a top electrode. A substrate can sit on a bottom electrode. Other configurations exist that apply RF power to the bottom electrode or to the both electrodes. One or more RF sources are used to deliver energy to the process area. DC and microwave sources can also be used to power one or more electrodes.

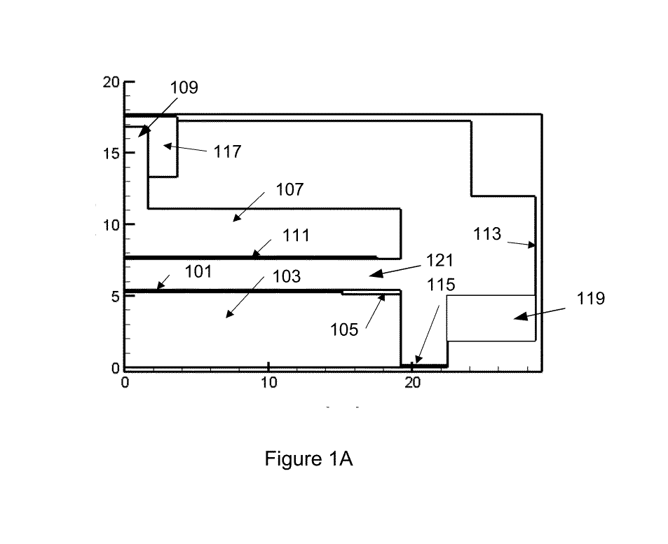

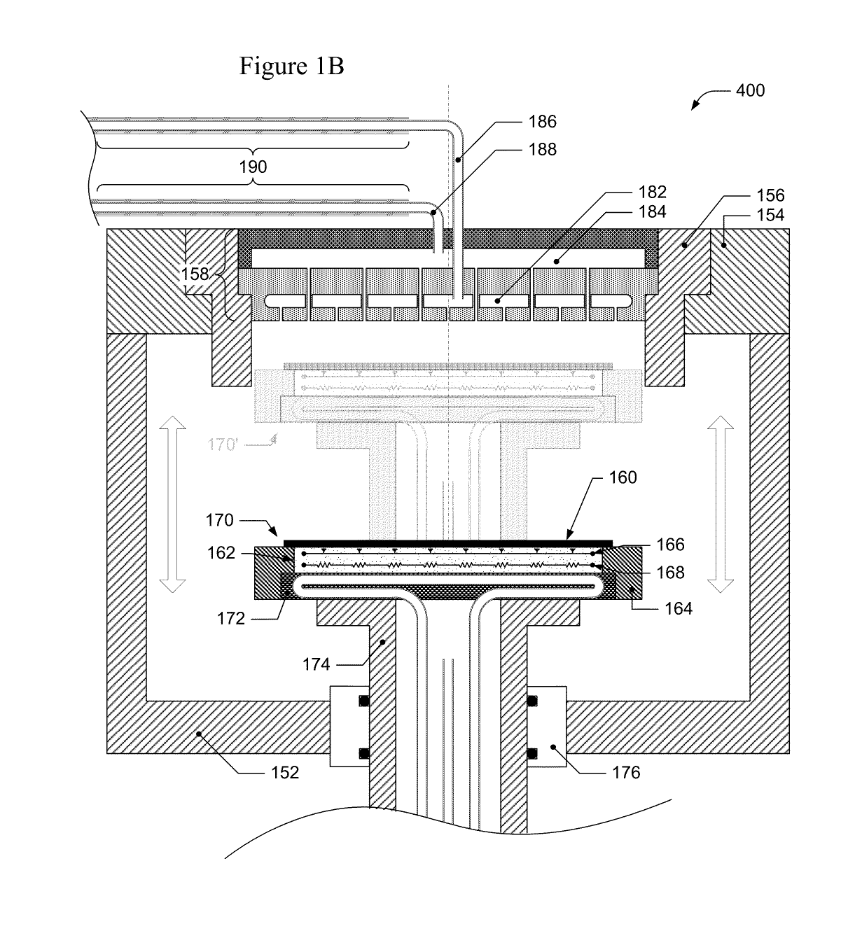

FIG. 1A is a graphical depiction of an example of a portion of a plasma processing chamber. A wafer 101 is shown on top of wafer support 103. A carrier ring 105 whose top surface is flush with the wafer surrounds the wafer 101. The carrier ring 105 can transfer wafers between stations of a multi-station process chamber and is usually made of a ceramic material. Vertically opposing the wafer support is a showerhead 107. Showerhead 107 is attached to the top of the chamber by a stem 109 through which the precursors flow to the perforated showerhead face plate 111. A ceramic collar 117 surrounds the top of the stem 109. A grounded chamber wall is shown as 113. Pumping ports 115 are located below and around the wafer support 103. An indexer 119 lifts the carrier ring 105 to transfer wafer 101 from station to station. The connection between the indexer 119 and the carrier ring 105 is not shown in FIG. 1A, but they can be connected in multiple places around the circumference of the carrier ring.

FIG. 1B is a graphical depiction of another example of a plasma processing chamber. Chamber housing 152, top plate 154, skirt 156, showerhead 158, pedestal column 174, and seal 176 provide a sealed volume for processing. Wafer 160 is supported by chuck 162 and insulating ring 164. Chuck 162 includes RF electrode 166 and resistive heater element 168. Chuck 162 and insulating ring 164 are supported by pedestal 170, which includes platen 172 and pedestal column 174. Pedestal column 174 passes through seal 176 to interface with a pedestal drive (not shown). Showerhead 158 includes plenums 182 and 184, which are fed by gas lines 186 and 188, respectively, which may be heated prior to reaching showerhead 158 in zone 190. 170′ and 170 refer to the pedestal, but in a lowered (170) and raised (170′) position.

While FIGS. 1A and 1B show examples of plasma processing chambers, the methods described herein are not limited to the particular examples shown in the Figures, and can be used in any type of processing chamber in which a substrate is in contact with a plasma, including physical vapor deposition (PVD) chambers and the like. These include chambers that do not include showerhead electrodes, for example.

There are several sources of particles that show up in the process plasma. Under some circumstances plasma may knock-off material from the showerhead or other chamber surfaces. It is also possible that the gas may carry particles as contamination. Finally, particles are created in the plasma with gas phase nucleation. Plasma-generated particles typically range in size from a few nanometers to about hundreds of nanometers. At least some of the particles may remain suspended in the plasma during processing, but when the plasma is extinguished, or collapses, the electric force that suspends the particles disappears. The particles are then subjected only to the ever-present forces of neutral drag, gravity, and thermophoresis. These particles may land on the wafer and cause a defect in the fabricated device. Methods and apparatus described herein allow the plasma particles to be evacuated prior to extinguishing the plasma.

In some embodiments, the methods and apparatus are used to control metal contamination. Controlling metal contamination is especially important for lower device node applications and as device nodes shrink. Metal contamination can be generated from chamber materials being eroded by the plasma. For example, an aluminum alloy showerhead can be eroded, generating several types of metal contaminant particles.

### Process

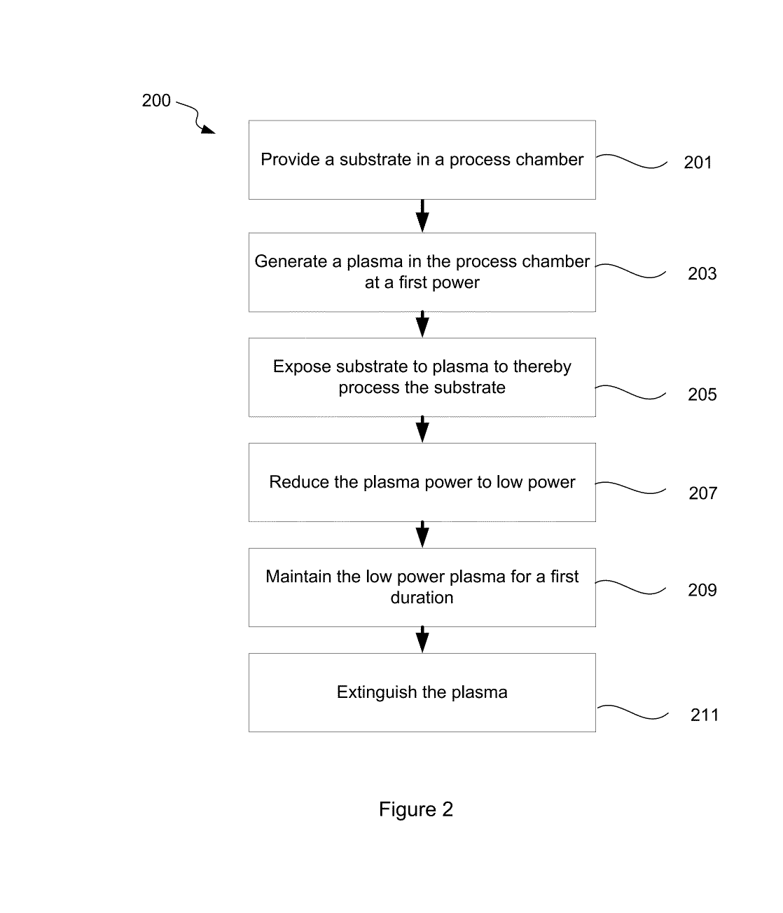

FIG. 2 is a process flow chart depicting operations in a method in accordance with an embodiment of this invention. In operation 201, a substrate is provided in a process chamber. The process chamber includes first and second electrodes above and below the substrate. It may also include additional electrodes. In operation 203, a plasma is generated at a first power. For example, the first power can be applied to a first electrode. According to various embodiments, the first electrode can be a showerhead with the second electrode including the substrate support and chamber walls, or the first electrode can be the substrate support with the second electrode including the showerhead and chamber walls. Other configurations are possible and within the scope of the methods and apparatus described herein.

In operation 205, the substrate is exposed to the plasma to thereby process the substrate. Operation 205 can involve one or more of exposing the substrate to reactive gases that become ionized in the plasma and react to deposit a film on the substrate surface, exposing the substrate to process gases that become activated in the plasma to treat or condition the substrate, and exposing the substrate to process gases that become ionized in the plasma to remove material from the substrate, or otherwise exposing the substrate to the plasma. In some embodiments, the process plasmas are deposition plasmas. In some embodiments, the process plasmas are plasmas used to provide surface treatment. In some embodiments, the process plasmas are plasmas used to remove small amounts of material such unwanted oxide on metal surfaces. These plasmas are distinct from pattern-definition etching plasmas.

In operation 207, the plasma power is reduced to a low power. In some embodiments, operation 207 can be done in multiple stages with a duration at each stage long enough for the plasma to respond. Typically, this occurs after the desired processing is complete, though in some embodiments, some amount of deposition or other processing can occur as or after the plasma power is reduced. As discussed further below, the plasma power is reduced to at or below a threshold power at which the plasma does not significantly generate particles from chamber surfaces, allowing particles to be swept out of the chamber. The low power is high enough to prevent the particles from falling on the substrate. The low power is maintained for a first duration in operation 209, sufficient to allow at least a large fraction of the particles to be pumped out. Finally, at an operation 211, the plasma is extinguished. The substrate is plasma processed without particle-generated defects.

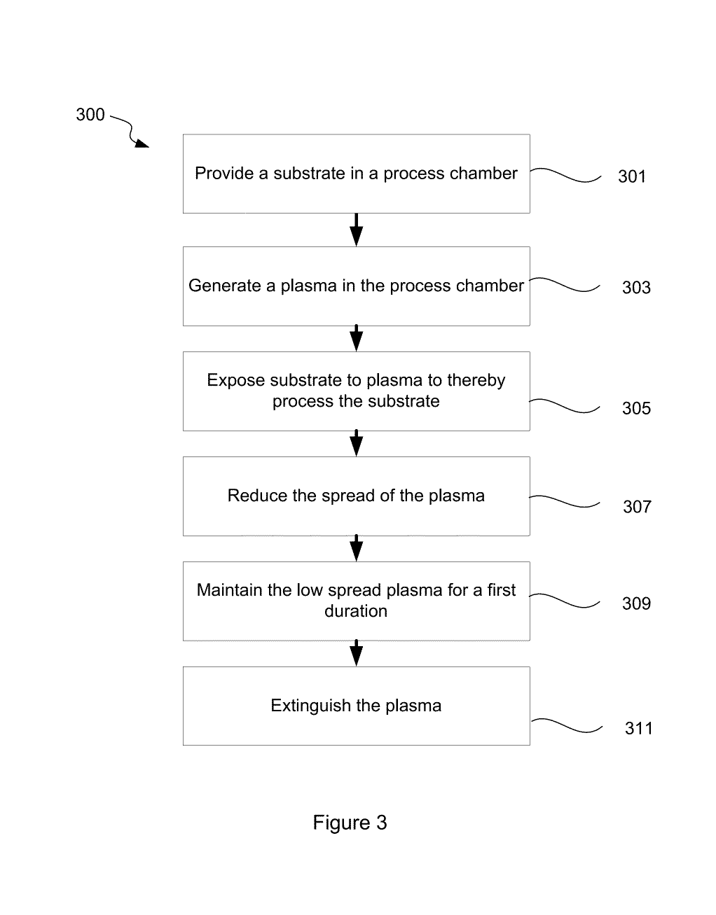

FIG. 3 is another process flow chart depicting operations in a method in accordance with an embodiment of this invention. In operation 301, a substrate is provided in a process chamber. In operation 303, a plasma is generated in the chamber. In operation 305, the substrate is exposed to the plasma to thereby process the substrate. Operation 305 can involve exposing the substrate to reactive gases that become ionized in the plasma and react to deposit material on the substrate surface, exposing the substrate to process gases that become activated in the plasma to treat or condition the substrate, exposing the substrate to process gases that become ionized in the plasma to remove material from the substrate, or otherwise exposing the substrate to the plasma.

In operation 307, the plasma spread is reduced. Typically, this occurs after the desired processing is complete, though in some embodiments, some amount of deposition or other processing can occur as or after the plasma spread is reduced. The low spread plasma is maintained for a first duration in operation 309, sufficient to allow at least a large fraction of the particles to be pumped out. Finally, at an operation 311, the plasma is extinguished. The substrate is plasma processed without particle-generated defects.

Reducing the plasma spread can involve controlling a bias voltage on an electrode, e.g., a pedestal electrode or a showerhead electrode. Electrode voltage is a function of plasma power and plasma impedance, with the latter a function of gas species, pressure, electrode shape, and chamber configuration, as well other process conditions and hardware configurations. Accordingly, in addition to or instead of lowering plasma power, reducing the plasma spread can involve increasing pressure and/or changing gas composition. In some embodiments, it can involve increasing pressure in stages in addition to or instead of lower power in stages.

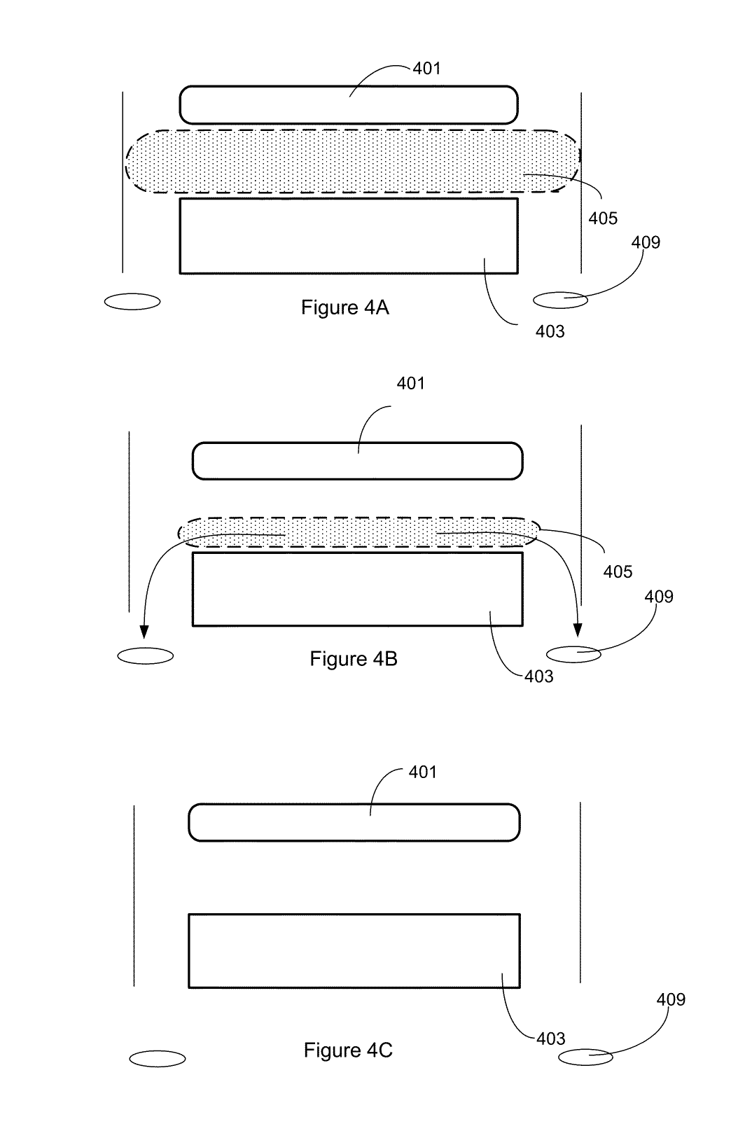

FIGS. 4A-4C show schematic depictions of stages in a method according to certain embodiments. The stages are plasma processing (FIG. 4A), metal particle extraction (FIG. 4B), and plasma collapse (FIG. 4C). In FIG. 4A, metal particles are suspended in plasma 405 above the wafer support 403 and below the showerhead 401. As noted above, the methods and apparatus described herein are not limited to particular process parameters. Rather, the methods and apparatus are applicable to any plasma assisted process where the plasma induces particle formation.

In the metal particle extraction stage, particles are extracted away from the space above the wafer, toward pump ports 409. Note that while pump ports 409 are depicted below the wafer, they may be positioned anywhere in the chamber. The spread of the plasma 405 is reduced. In some embodiments, the plasma power is reduced to at or below a threshold level. The last stage is the plasma collapse, as shown on FIG. 4C. Power to the electrode is switched off, extinguishing the plasma 205 in FIG. 4B. After the plasma is extinguished, the wafer may be removed from the wafer support and transferred to the next process. In a multi-station chamber, the next process may be at the next station. In a single station chamber, the next process may be in another chamber attached to the same semiconductor processing tool or to another tool altogether.

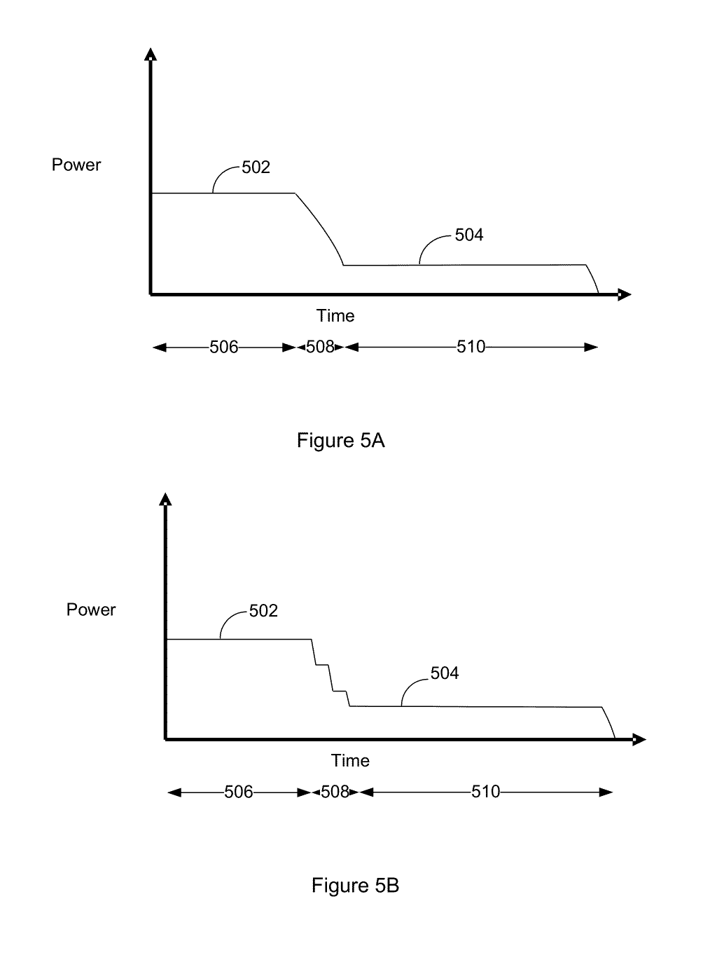

FIGS. 5A and 5B are diagrams depicting plasma power vs. time according to certain embodiments. It should be noted that the scale of certain time periods is exaggerated for ease of illustration. Time period 506 corresponds to at least a portion of the plasma processing stage. The time period 506 may range for example from seconds to an hour depending on the plasma processing that the substrate is undergoing. The plasma power level 502 is set at the level to best meet process requirements. Time period 508 corresponds to a relatively short amount of time during which the plasma power is decreased. In FIG. 5A, the plasma power is reduced continuously to a particle extraction power 504; in FIG. 5B, the plasma power is stepped down to the particle extraction power 504. As indicated, the time period 508 is relatively short and can range from about 10 milliseconds to 3 seconds, depending on the number of intermediate power levels and the time it takes for the plasma to respond at each level. In some cases, the time period 508 may be longer than 3 seconds. Time period 510 corresponds to the particle extraction phase and can range from about, e.g., 3-10 seconds. The time period 510 is typically significantly longer than the time period 508; for example, it may be at least twice as long, four times as long or ten times as long.

In some embodiments, the particle extraction power 504 is at or below a threshold power at which the metal particle generation is substantially eliminated or at least sharply reduced, while still high enough to maintain the plasma. The plasma is maintained at that level for a period of time sufficient to sweep out the particles.

According to various embodiments, the methods described herein can be used to reduce metal contamination, as well as contamination by other types of plasma-generated particles. Metal particles that can be extracted include aluminum (Al). calcium (Ca), chromium (Cr), cobalt (Co), iron (Fe), lithium (Li), magnesium (Mg), manganese (Mn), molybdenum (Mo), nickel (Ni), potassium (K), sodium (Na), titanium (Ti), vanadium (V), and zinc (Zn). The methods described herein can be used to reduce contamination from particles formed from deposition or removal material.

### Parameters

The processing plasma power can be determined based on process optimization and will depend on the type plasma source, chamber configuration, and process gas composition. Power can be expressed in terms of substrate area, i.e., as a power density. In certain embodiments, a power density of at least about 0.014 W/cm² may be used. Example power densities can range from about 0.01 W/cm² to about 14 W/cm² for RF plasmas.

The processing gas composition is also determined based on process optimization. The plasma can have an inert or reactive chemistry depending on the particular embodiment. Examples of inert chemistries include argon. In some embodiments, the plasma may be oxidative. In some embodiments, the plasma may be reductive. In some embodiments, the gas composition may be changed during the plasma-off process. This can aid in reducing particle generation during this time period. For example, a hydrogen flow may be turned off in an Ar/H₂ plasma during a plasma power step-down. Flow rate of the process gases may also increase to facilitate sweep of the particles suspended in the plasma. Example pressures can range from about 1 mTorr to 760 Torr.

### Example 1

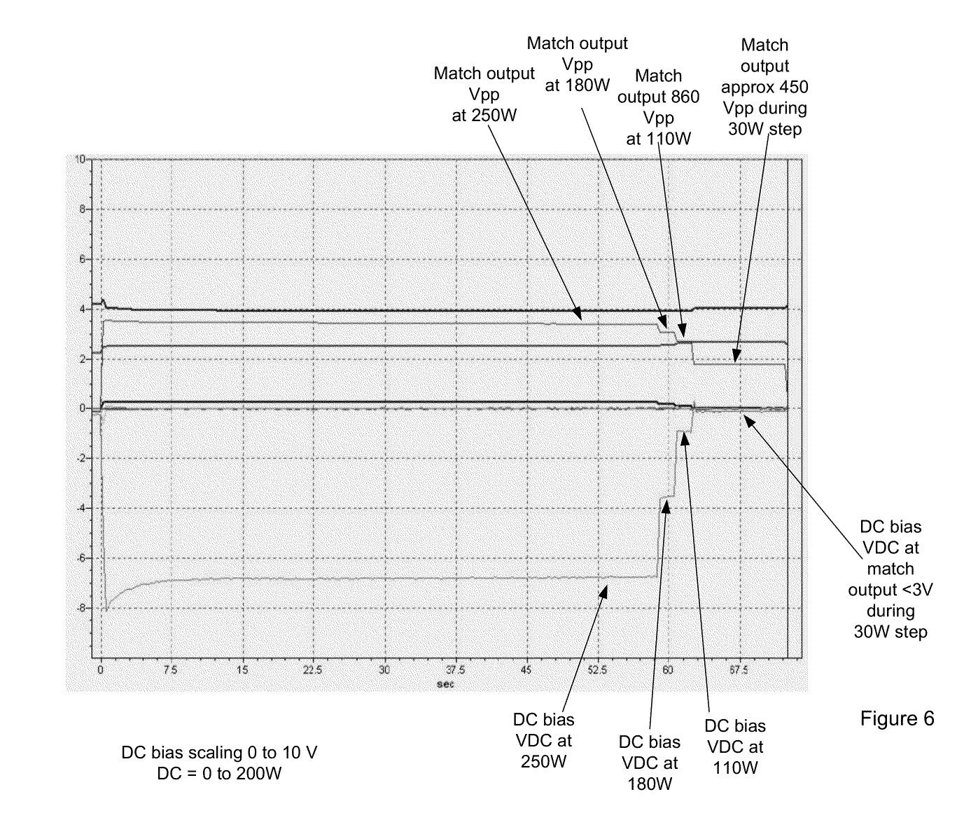

A matching network configuration to measure RF power, Match Output Vpp and DC bias allows characterization of power step/ramp down to achieve a desired level of contamination. FIG. 6 shows bias match data in a RF system for RF power turned off with 250 W, 180 W, 110 W and 30 W steps. The amount of plasma spread is quantified by a DC bias measurement picked up by the matching network signal.

In FIG. 6, stepping down from 250 W to 180 W results in a drop of about 70V in the measured DC bias voltage, from 180 W to 110 W results in a drop of about 50V, and from 110 W to 30 W results in a drop of about 47V. The DC bias voltage at match output is less than about 3V during the 30 W step. The plasma is held at 30 W—the reduced Vpp and VDC at match output seen at the 30 W during the RF off process allows the plasma to shrink to a smaller area but not collapse completely. Particles can then be evacuated during a first duration. It is possible that stepping down power could generate larger change in electrode voltage and result in quicker change in plasma spread than can be observed by DC bias voltage readings.

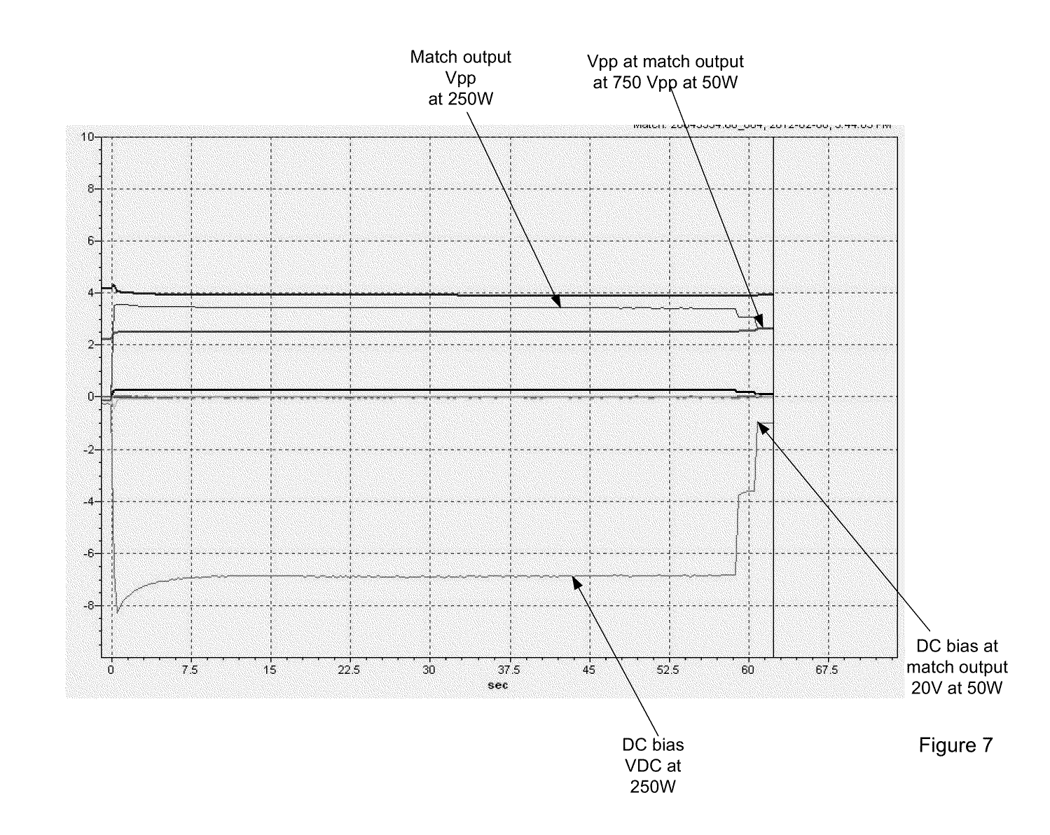

If the DC voltage is not adequately lowered during the evacuation stage, particles may remain in the plasma. Compare FIG. 7 with FIG. 6: FIG. 7 shows bias match data in the same RF system as in FIG. 6 for RF power turned off with 250 W, 180 W, 110 W and 50 W steps. The 50 W step during the RF off processes contributes adequate electrode voltage and DC bias for plasma to remain fairly spread. As a result, contamination levels are not significantly reduced as compared to not stepping down.

### Example 2

Al and Zn trace levels were measured after an in-situ plasma pre-treatment and non-plasma deposition of 2 kA of dielectric material on semiconductor substrates. Pre-treatment plasma power, pre-treatment time, and pre-treatment RF off process were varied.

Al trace metal level

| | | | RF stepped | |
|---|---|---|---|---|
| | Pre-treatment plasma | Pre-treatment | to 30 W | Al × E10 |
| Run | power (W) | time (s) | (evacuation) | atom/cm² |
| A | 250 | 60 | no | 18 |
| B | 250 | 30 | no | 24 |
| C | 100 | 60 | no | 22 |
| D | 250 | 30 | yes | 3.4 |
| E | 100 | 60 | yes | 0.7 |

Zn trace metal level

| | | | RF stepped | |
|---|---|---|---|---|
| | Pre-treatment plasma | Pre-treatment | to 30 W | Zn × E10 |
| Run | power (W) | time (s) | (evacuation) | atom/cm² |
| A | 250 | 60 | no | 2.7 |
| B | 250 | 30 | no | 1.0 |
| C | 100 | 60 | no | 0.9 |
| D | 250 | 30 | yes | 0.5 |
| E | 100 | 60 | yes | 0.3 |

Al trace contamination was fairly constant with changes in pre-treatment time and plasma power. However, a big reduction in contamination was seen with the RF off process having a decreasing set point and lower final step threshold power for evacuating the particles (Runs D and E). Zn also showed reduced contamination for these runs.

### Apparatus

The present invention can be implemented in many different types of apparatus, such as CVD reactors, etch chambers, and the like. An example of a plasma processing apparatus is described above with respect to FIG. 1. Generally, the apparatus will include one or more chambers or “reactors” (sometimes including multiple stations) that house one or more wafers and are suitable for wafer processing. Each chamber may house one or more wafers for processing. The one or more chambers maintain the wafer in a defined position or positions (with or without motion within that position, e.g. rotation, vibration, or other agitation). While in process, each wafer is held in place by a pedestal, wafer chuck and/or other wafer holding apparatus. For certain operations in which the wafer is to be heated, the apparatus may include a heater such a heating plate. In many embodiments, the chamber includes spaced electrodes such as parallel-plate type electrodes that are configured to generate capacitively-coupled plasmas. For example, a showerhead and wafer support may each act as an electrode. In some embodiments, however, HDP CVD (High Density Plasma Chemical Vapor Deposition) system that uses an inductively-coupled plasma may be used in conjunction with the methods described herein.

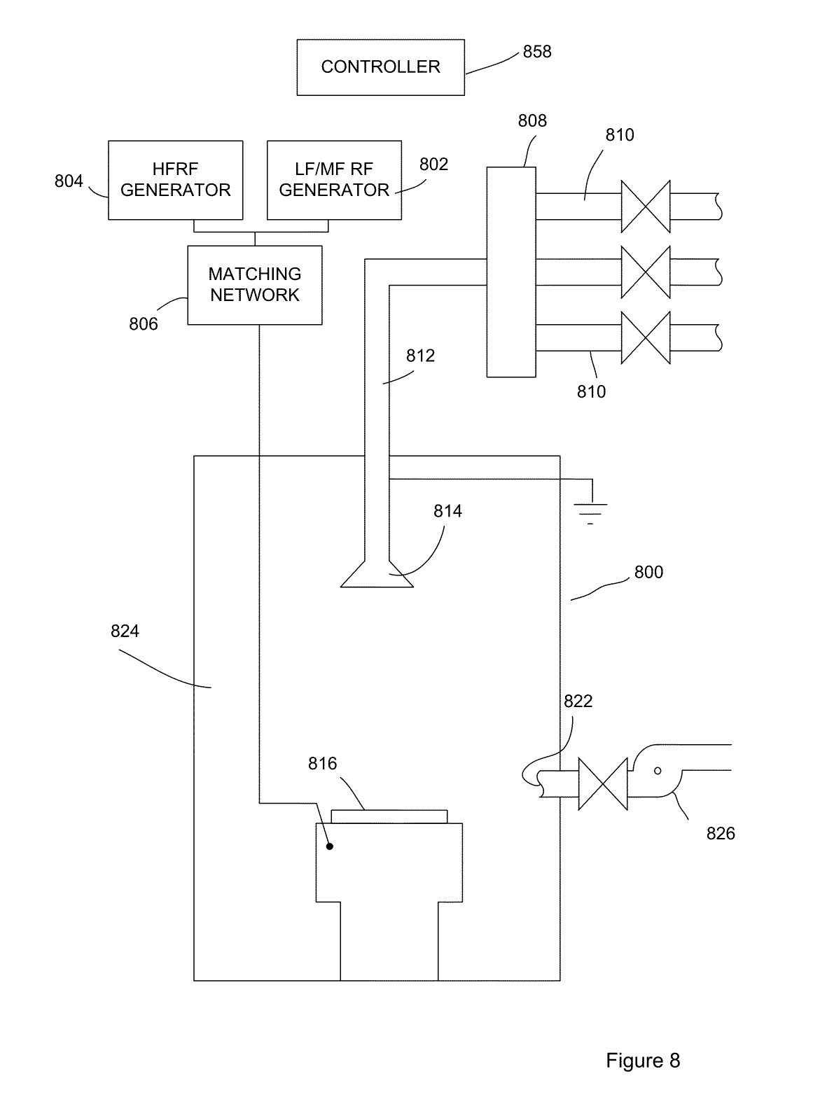

FIG. 8 provides a simple block diagram depicting various components arranged for implementing the methods described herein. As shown, a reactor 800 includes a process chamber 824, which encloses other components of the reactor and serves to contain the plasma generated by a capacitor type system including a wafer support 818 working in conjunction with a grounded showerhead 814. A high-frequency RF generator 804 and a low-frequency RF generator 802 are connected to a matching network 806 that, in turn is connected to wafer support 818.

Within the reactor, a wafer support 818 supports a substrate 816. The support typically includes a chuck or platen and a fork or lift pins to hold and transfer the substrate during and between the deposition reactions. The chuck may be an electrostatic chuck, a mechanical chuck or various other types of chuck as are available for use in the industry and/or research.

The process gases are introduced via inlet 812. Multiple source gas lines 810 are connected to manifold 808. The gases may be premixed or not. Appropriate valving and mass flow control mechanisms are employed to ensure that the correct gases are delivered during the deposition and plasma treatment phases of the process. In case the chemical precursor(s) is delivered in the liquid form, liquid flow control mechanisms are employed. The liquid is then vaporized and mixed with other process gases during its transportation in a manifold heated above its vaporization point before reaching the deposition chamber.

Process gases exit chamber 800 via an outlet 822. A vacuum pump 826 (e.g., a one or two stage mechanical dry pump and/or a turbomolecular pump) can draw process gases out and maintains a suitably low pressure within the reactor by a close loop controlled flow restriction device, such as a throttle valve or a pendulum valve.

The power and frequency supplied by matching network 806 is sufficient to generate a plasma from the process gas, for example, 50-2500 W of total energy per station. In an example process, the high frequency RF component can be between 2-60 MHz; for example, the HF component is 13.56 MHz, with an LF or medium frequency (MF) component between about 100 kHz-400 kHz. As noted above, the methods may be used with any appropriate power source and are not limited to RF sources.

Controller 858 may be connected to components and control applied plasma power, process gas composition, pressure, and temperature. Machine-readable media may be coupled to the controller and contain instructions for controlling process conditions including plasma power off conditions. The controller will typically include one or more memory devices and one or more processors. The processor may include a CPU or computer, analog and/or digital input/output connections, stepper motor controller boards, etc.

In certain embodiments, the controller controls all of the activities of the apparatus. The system controller executes system control software including sets of instructions for controlling the timing, supply of process gases, chamber pressure, chamber temperature, wafer temperature, plasma power and exposure time, and other parameters of a particular process. Other computer programs stored on memory devices associated with the controller may be employed in some embodiments.

Typically there will be a user interface associated with controller 808. The user interface may include a display screen, graphical software displays of the apparatus and/or process conditions, and user input devices such as pointing devices, keyboards, touch screens, microphones, etc.

The computer program code for controlling the processes can be written in any conventional computer readable programming language: for example, assembly language, C, C++, Pascal, Fortran or others. Compiled object code or script is executed by the processor to perform the tasks identified in the program. Signals for monitoring the process may be provided by analog and/or digital input connections of the controller. The signals for controlling the process are output on the analog and digital output connections of the deposition apparatus. The system software may be designed or configured in many different ways. For example, various chamber component subroutines or control objects may be written to control operation of the chamber components necessary to carry out the inventive processes. Examples of programs or sections of programs for this purpose include plasma power control code, gas inlet control code. In one embodiment, the controller includes instructions for performing processes of the invention according to methods described above.

The system or instrumentation used can monitor forward power, electrode bias voltage, and DC bias voltage in the same time scale in a high sample rate (e.g., faster than 10 msec). The measurements used for forward power, reflected power, match output bias voltage and DC bias voltage seen at match output can be generated from a customized match.

What is claimed is:

1. A method comprising:
exposing a substrate in a process chamber to a plasma at a first plasma power; and
performing a plasma extinguishing process comprising reducing the first plasma power to a second plasma power, maintaining the second plasma power for a first duration, and after the first duration, extinguishing the plasma.

2. The method of claim 1, wherein the plasma is an RF plasma.

3. The method of claim 2, wherein the first plasma power is at least about 0.014 W/cm².

4. The method of claim 2, wherein the second plasma power is less than about 0.007 W/cm².

5. The method of claim 1, wherein the plasma is a DC plasma.

6. The method of claim 1, wherein the plasma is microwave plasma.

7. The method of claim 1, wherein reducing the first plasma power to a second plasma power comprises ramping down the plasma power.

8. The method of claim 1, wherein reducing the first plasma power to a second plasma power comprising stepping down the plasma power.

9. The method of claim 1, wherein the plasma power is reduced over a time period ranging from 10 ms to 3 seconds.

10. The method of claim 1, wherein a particle is flushed from the chamber.

11. The method of claim 1, wherein the first duration is between about 3 and 10 seconds.

12. The method of claim 1, wherein the plasma is a deposition, surface conditioning or removal plasma.

13. A method comprising:
generating a plasma in a processing chamber;
exposing a substrate in the processing chamber to the plasma;
reducing the plasma spread;
flushing particles from the chamber while the plasma is at the reduced spread.

14. The method of claim 13, further comprising extinguishing the plasma.

15. The method of claim 13, wherein reducing the plasma spread comprises reducing the plasma power.

16. The method of claim 1, wherein the plasma is a deposition, surface conditioning or removal plasma.

17. A semiconductor processing apparatus comprising:
a substrate support;
a first electrode electrically connected to a first plasma generator;
a second electrode;
a pumping port; and
a controller, said controller comprising instructions for applying a first power to the first electrode, reducing the first power to a second power, maintaining the second power for a first duration, and turning off power to the first electrode.

18. The apparatus of claim 17, wherein the first electrode comprises a showerhead.

19. The apparatus of claim 17, wherein the first electrode comprises the substrate support.
